(19) United States
(12) Patent Application Publication
(10) Pub. No.: US 2011/0254260 A1
(43) Pub. Date: Oct. 20, 2011

(54) IMAGE PRINTED MATTER AND IMAGE FORMING METHOD

(75) Inventors: Mitsutoshi NAKAMURA, Aichi (JP); Shigenori KOUNO, Tokyo (JP); Kazuyoshi GOAN, Kanagawa (JP); Kouichi SUGAMA, Tokyo (JP); Ito KOGA, Tokyo (JP)

(73) Assignee: KONICA MINOLTA BUSINESS TECHNOLOGIES, INC., Tokyo (JP)

(21) Appl. No.: 13/082,846

(22) Filed: Apr. 8, 2011

(30) Foreign Application Priority Data
Apr. 19, 2010 (JP) 2010-095663

(51) Int. Cl. B42D 15/00; G03G 13/20

(52) U.S. Cl. 283/94; 430/124.1

(57) ABSTRACT

An image forming method for forming an image printed matter, includes the steps of: forming a toner image with toner particles on a photoreceptor; transferring the toner image from the photoreceptor onto a substrate; laminating an toner holding material layer on the substrate so as to embed the toner image in the toner holding material layer so that the toner holding material layer holds the toner image therein and the image printed matter is formed, wherein the toner holding material layer is composed of a gel including a liquid dispersion medium having a contact angle of 20 to 110 degrees to the image supporting substrate.

This application is based on Japanese Patent Application No. 2010-095663 filed on Apr. 19, 2010, in Japanese Patent Office, the entire content of which is hereby incorporated by reference.

### BACKGROUND OF THE INVENTION

The present invention relates to an image printed matter in which a toner holding material layer holding a toner image is laminated on an image supporting substrate, and to an image forming method for forming this image printed matter.

Conventionally, in an electro-photography type image forming method of forming a toner image by developing an electrostatic image with toner, as a fixing method of fixing the toner image onto an image supporting substrate, methods utilizing a heat pressing roller, a flash light or the like are employed (for example, refer to Patent document 1 and Patent document 2).

However, since these methods fix a toner image onto an image supporting substrate by deforming the toner image, these methods need a large amount of energy. Accordingly, these methods are not desirable from a viewpoint of energy saving.

As a fixing method which realizes the energy saving, a technique to fix a toner image with only pressure without using heat is proposed (for example, refer to Patent document 3). Further, proposed is a method which provides concave portions on the surface of an image supporting substrate and fixes toner particles by making them adhere electrostatically in the concave portions (for example, refer to Patent document 4).

However, in such a method which uses only pressure, there is a problem that a toner image is not sufficiently fixed onto an image supporting substrate, so that the quality of the formed image becomes low. Further, in a method which provides concave portions, since it may be difficult to avoid the detachment of toner particles from the concave portions, there is a problem that pollution is caused by detached toner particles.

Furthermore, in the image forming methods disclosed in Patent documents 1 to 4, image is formed such that toner images exist in image portions and toner images do not exist in non-image portions. Therefore, in such images, since slight level differences are formed between the image portions and the non image portions, there is a problem that images with high quality cannot be obtained.

In order to solve the problem of the level differences between the image portions and the non image portions, a technique to make toner images exist in non-image portions is proposed (for example, refer to Patent document 5). Further, proposed is a method which provides a resin layer on the surface of an image supporting substrate and fixes toner images on the surface of the image supporting substrate by melting the toner images and the resin layer of the image supporting substrate (for example, refer to Patent document 6).

Even with the method disclosed by Patent document 5, gaps are caused between toner and toner. Accordingly, the degree of white turbidity of the formed image printed matter becomes high, so that the depth of color cannot be acquired sufficiently. Also, even with the method, disclosed by Patent document 6, to melt a resin layer and a toner image, images with sufficient quality cannot be obtained.

As mentioned above, conventionally, there is not such an image forming capable of obtaining images with high quality while achieving energy saving.
Patent document 1: Japanese Unexamined Patent Publication No. 2004-101648 official report
Patent document 2: Japanese Unexamined Patent Publication No. 5-297626 official report
Patent document 3: Japanese Unexamined Patent Publication No. 6-242627 official report
Patent document 4: U.S. Pat. No. 4,085,505 official report
Patent document 5: Japanese Unexamined Patent Publication No. 9-197858 official report
Patent document 5: Japanese Unexamined Patent Publication No. 11460905 official report

### SUMMARY OF THE INVENTION

The present invention has been achieved under the above circumstances, and an object of the present invention is to provide an image printed matter which can obtain high image quality and image strength without causing image change due to external force and an image forming method of forming such an image printed matter. Further, an object of the present invention is to provide an image forming method capable of obtaining an image printed matter which can obtain high image quality and image strength without causing image change due to external force, while achieving energy saving.

The above object can be attained by the following method to which an aspect of the present invention is reflected.

An image forming method includes the steps of:

forming a toner image with toner particles on a photoreceptor;

transferring the toner image from the photoreceptor onto a substrate;

laminating an toner holding material layer so as to embed the toner image in the toner holding material layer so that the toner holding material layer holds the toner image therein,

wherein the toner holding material layer is composed of a gel including a liquid dispersion medium having a contact angle of 20 to 110 degrees to the image supporting substrate.

### BRIEF DESCRIPTION OF THE DRAWINGS

FIG. 1a is a schematic diagram for explaining an image forming method relating to the first embodiment of the present invention and showing a state that a toner image is formed on an image supporting substrate, FIG. 1b is a schematic diagram showing a state that an image fixing sheet is superimposed, and FIG. 1c is a schematic diagram showing a state that the toner image is fixed by being supported by the image supporting substrate.

FIG. 2a is a schematic diagram for explaining an image forming method relating to the second embodiment of the present invention and showing a state that a toner image is formed on a photoconductor, FIG. 2b is a schematic diagram showing a state that a toner image is held by a toner holding material layer of an image fixing sheet, and FIG. 2c is a schematic diagram showing a state that the toner image is fixed by being supported by the image supporting substrate.

FIG. 3a is a schematic diagram for explaining an image forming method relating to the third embodiment of the present invention and showing a state that a toner image is formed on a photoconductor, and FIG. 3b is a schematic diagram showing a state that the toner image is fixed by being supported by a toner holding material layer on an image supporting substrate.

FIG. 4 is a schematic diagram showing an example of an embodiment of an image printed matter of the present invention.

### DETAILED DESCRIPTION OF THE PREFERRED EMBODIMENT

Hereafter, an image printed matter and an image forming method of the present invention will be explained in detail. However, the present invention is not limited to embodiments in the detailed explanation.

### The First Embodiment

The image forming method according to the first embodiment of the present invention is an image forming method which makes an image supporting substrate to support a toner image formed by toner particles thereon, and then laminates a toner holding material layer so as to make the toner holding layer hold the toner image so that an image printed matter is formed, and the image forming method is characterized in that the toner holding material layer is composed of a gel formed by a liquid dispersion medium having a contact angle of 20 to 110 degrees to the image supporting substrate.

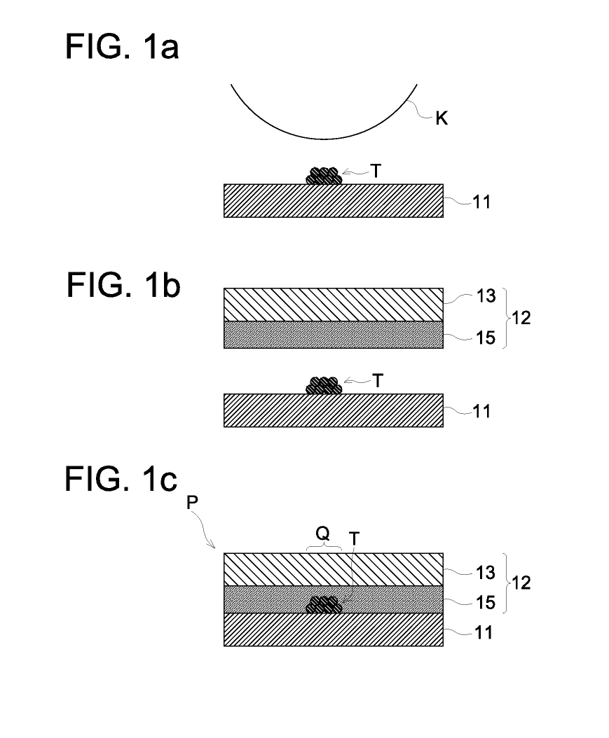

In the image forming method of the present invention, concretely, as shown in FIG. 1a to FIG. 1c, toner image T electrostatically formed by toner particle on a photoconductor K is transferred onto an image supporting substrate 11, and then on the image supporting substrate 11 on which the toner image T is supported, for example, an image fixing sheet 12 in which a toner holding material layer 15 is laminated on one surface of an surface protective layer 13 is superimposed such that the image supporting substrate 11 is brought in contact with the toner holding material layer 15, whereby treatment to embed the toner image T in the toner holding material layer 15 so that the toner image T is held by the toner image holding material layer 15. With this, a process to fix the toner image T onto the image supporting substrate 11 is conducted, whereby an image printed matter P is obtained. At this time, this fixing process does not need heating. However, in order to obtain an image printed matter with high image quality, a heating treatment may be conducted at a low temperature, for examples, about 60 to 80° C.

An external force to embed a toner image T may differ depending on the mechanical strength of toner particles constituting the toner image T and the kind of gel constituting the toner holding material layer 15. However, the external force may be made to be a pressing force of 1.00×10³ to 1.00×10⁸ Pa. The external force to embed a toner image T in an toner holding material layer may be, for example, an electrostatic force applied by an appropriate transfer device, a pressing force with which an image fixing sheet 12 is pressed onto an image supporting substrate 11, or a combination of these forces.

In the image forming method of the present invention, when a degree of particle shape of toner particles used to constitute a toner image T is made A and a degree of particle shape of toner particles constituting a toner image T held by a toner holding material layer is made B, it is desirable to satisfy the following relational expression (1).

1.0≧B/A≧0.9 Relational expression (1)

Herein, the degree of particle shape of toner particles is represented by (minimum diameter of a projection image/maximum diameter of the projection image).

The value of (B/A) represents a magnitude of change of a degree of particle shape of toner particles between before being used to form a toner image T and after having been held by a toner holding material layer 15, and when the value of (B/A) is in the range of the abovementioned relational expression (I), an image printed matter with high image quality can be formed by small external force, i.e., a small amount of energy. On the other hand, when the value of (B/A) representing the magnitude of change of a degree of particle shape is less than 0.9, the amount of energy needed to obtain an image printed matter P becomes large. As a result, since the environmental load becomes large, it is not desirable.

The degree of particle shape A of toner particles used to form a toner image T is concretely obtained as fallows. A toner image T formed electrostatically on a photoconductor K is peeled off and observed by a scanning electron microscope (SEM) “JSM-7401F” (manufactured by JEOL Co., Ltd.) so as to take an image with a magnification of 2,000 times into “a LUZEX image analyze” (manufactured by Nireco Corp.). Then, a maximum diameter and minimum diameter of a projection image of a particle are measured for each toner particle, and a degree of particle shape is obtained by the calculation of (minimum diameter/maximum diameter). Subsequently, the degree of particle shape A of toner particles is obtained by the calculation of an average value of the respective degrees of particle shape of 100 toner particles.

Further, the degree of particle shape B of toner particles having been held by a toner holding material layer 15 is concretely obtained as fallows. The cross sectional surface of a cut piece of an image printed matter obtained by this image forming method is observed by a scanning electron microscope (SEM) “JSM-7401F” (manufactured by JEOL Co., Ltd.) so as to take an image with a magnification of 2,000 times into “a LUZEX image analyzer” (manufactured by Nireco Corp.). Then, a maximum diameter and minimum diameter of a projection image of a particle are measured for each toner particle, and a degree of particle shape is obtained by the calculation of (minimum diameter/maximum diameter). Subsequently, the degree of particle shape B of toner particles is obtained by the calculation of an average value of the respective degrees of particle shape of 100 toner particles.

The degree of particle shape A of toner particles used to form a toner image T is preferably 0.40 to 1.00 in concrete terms, and more preferably 0.60 to 1.00. Further, the degree of particle shape B of toner particles having been held by the toner image holding material layer 15 is preferably 0.40 to 1.00 in concrete terms, and more preferably 0.60 to 1.00.

The abovementioned relational expression (I) can be attained, for example, by the use of toner particles having a 10% deformation intensity of 1 to 100 MPa (hereafter, also referred to as “hard toner particles”). This 10% deformation intensity is a value measured at a compression test mode by the use of a minute compression tester “MCT-W201” (manufactured by Shimadzu Corp.).

Moreover, the image forming method of the present invention is not limited to the use of hard toner particles, and the image forming method may use toner particles (hereafter, also referred to “elastic toner particles”) which have a recovery ratio of 70% or more and have elasticity and/or shape memory properties. By the use of elastic toner particles having such a recovery ratio, even in the case where toner particles are held on deformed states by a toner holding material layer, when the toner particles are separated from the toner holding material layer and subjected to a recovery treatment in accordance with necessity, it become possible to obtain toner particles for reuse from the toner particles such that the toner particles for reuse exhibit behavior similar to initial toner particles, as mentioned later. The recovery of an elastic toner particles is a value measured in load and unloading check mode using a minute compression tester “DUH-W 201 S” (manufactured by Shimadzu Corp.). The recovery ratio of elastic toner particles is a value measured at a load and unload test mode by the use of a minute compression tester “DUH-W 201S” (manufactured by Shimadzu Corp.).

According to the above image forming methods, since a toner image T can be fixed onto an image supporting substrate 11 basically without providing heat, energy saving can be attained. Further, since the toner image T is held in the toner holding material layer 15, its surface is made to a state with high uniformity so as to make no level difference between an image-formed portion Q and a non-image-formed portion and to provide high image quality. Furthermore, since a material composed of a gel formed by a liquid dispersion medium having a contact angle within a specific range to the image supporting substrate 11 is used as the toner holding material layer 15, a sufficient close contact can be obtained between the image supporting substrate 11 and the toner holding material layer 15 so as to provide a high image strength without causing image collapse due to peel-off between the image supporting substrate 11 and the toner holding material layer 15 by a small external force. Moreover, the liquid dispersion medium is prevented from transferring to the image supporting substrate 11, whereby a change of an image over time is not caused and an image printed matter with excellent image stability can be obtained.

### [Image Printed Matter]

As shown in FIG. 1c, in an image printed matter P of the present invention, a toner holding material layer 15 is laminated on an image supporting substrate 11, and the toner holding material layer 15 holds a toner image T formed by toner particles. Further, a surface protective layer 13 may be formed on the toner holding material layer 15 if needed.

### [Toner Holding Material Layer]

In the present invention, the toner holding material layer 15 is composed of a gel (hereafter, also referred to as “specific gel”) formed by a liquid dispersion medium having a contact angle of 20 to 110 degrees to the image supporting substrate 11. In concrete terms, the specific gel is colloid in which a gel material being a solid dispersoid is dispersed in a liquid dispersion medium, and the specific gel exhibits high viscosity due to the network of the gel material, has not flowability in an ordinary state, and is a solid state as a whole.

When the liquid dispersion medium of the specific gel has a contact angle within the abovementioned range to the image supporting substrate 11, a sufficient close contact can be obtained between the image supporting substrate 11 and the toner holding material layer 15, so that an image printed matter is provided with a high image strength without causing image collapse due to peel-off between the image supporting substrate 11 and the toner holding material layer 15 by a small external force. Moreover, the liquid dispersion medium is prevented from transferring to the image supporting substrate, whereby a change of an image over time is not caused and the image printed matter is provided with excellent image stability. On the other hand, when the liquid dispersion medium of the specific gel has a too small contact angle to the image supporting substrate 11, since the close contact between the image supporting substrate 11 and the toner holding material layer 15 becomes excessively high, the transfer of the liquid dispersion medium to the image supporting substrate 11 takes place over time so that the network state of the gel material is disturbed. As a result, the toner image T held by the toner holding material layer 15 deforms, and excellent image stability cannot be obtained. Further, as mentioned later, when the toner holding material layer 15 is peeled off from the image supporting substrate 11, the toner holding material layer 15 cannot be peeled off or the toner holding material layer 15 becomes difficult to be peeled off from the image supporting substrate 11 without being peeled off appropriately such that the image supporting substrate 11 is fractured or the toner holding material layer 15 partially remains on the image supporting substrate 11. Further, when the liquid dispersion medium of the specific gel has an excessively large contact angle to the image supporting substrate 11, since the close contact between the image supporting substrate 11 and the toner holding material layer 15 becomes low, image collapse is caused due to peel-off between the image supporting substrate 11 and the toner holding material layer 15 by a little external force, and high image strength cannot be obtained.

The contact angle of a liquid dispersion medium of a specific gel to the image supporting substrate 11 is a contact angle of this liquid dispersion medium or a liquid (hereafter, referred to as “compatible solvent”) soluble to the liquid dispersion medium to the image supporting substrate 11, and in concrete terms, on the condition that a droplet of a liquid dispersion medium or a compatible solvent is made to adhere on an image supporting substrate 11 arranged horizontally, the contact angle is an angle formed by the tangent line of this droplet and the surface of the image supporting substrate 11 in the cross sectional view of the droplet.

The contact angle of a liquid dispersion medium of a specific gel to the image supporting substrate 11 is measured automatically by the use of an automatic contact angle meter “DM-51” (manufactured by Kyowa Interface Science Co., LTD.) and an analysis software “FAMAS” in such a way that an operation of sampling a liquid in an amount of 2.5 μL is automatically conducted by the use of a 22G syringe needle, and successively an acknowledgement of a liquid sample adhesion and a contact angle measurement are conducted automatically. Here, the contact angle measurement is conducted within 5 seconds after the acknowledgement of a liquid sample adhesion.

It is desirable that this specific gel does not have flowability on the condition that it is not applied with an external force and it exhibits a flow condition by being applied with an external force. In concrete terms, for example, it may be considered that the specific gel has a thixotropy property in which a material is a gel state in an ordinary condition and changes into a sol sate by being applied with an external force. Specifically, it is desirable that the specific gel has flowability (hereafter, also referred to as “specific flowability”) such that when toner particles are embedded in the specific gel, the magnitude of a change of the degree of particle shape is suppressed to be small.

By the use of a specific gel having such a specific flowability, a toner image formed by toner particles electrostatically adhering on a photoconductor K can be embedded in a toner holding material layer 15 on the condition that electrostatic charges are maintained on each toner particles.

Moreover, as such a specific gel, a material being incompatible with a resin constituting toner particles (hereafter, also referred to as “toner resin”) may be appropriately selected, and further a material having a high compatibility with toner particles is desirable.

When the specific gel is recycled as a gel material via a separation treatment mentioned later and the recycled gel material is used as an image formation material, the specific gel is preferable to be able to be reused as a material to form a toner holding material layer served for anther image formation.

As such a specific gel, employed may be an organogel composed of a gel material (dispersed material, dispersoid) such as a silicone type, acrylic type, vinyl type, or urethane type resin, elastomer, or rubber and an organic solvent or oil, and a hydrogel composed of a gel material, such as the above gel materials or a water soluble polymer and a water-based solvent.

In concrete terms, examples of the silicone type resin include dimethyl siloxane, diphenyl siloxane, methylvinyl siloxane, methyl-phenyl siloxane, fluoro siloxane, trifluoro siloxane, trifluoropropyl siloxane, chloromethyl siloxane, cyanoethyl siloxane, polyether siloxane, fluoropolyether siloxane, amino siloxane, and the like.

Examples of the acrylic type resin includes 2-ethyl hexyl acrylate, n-butyl acrylate, and copolymers of methyl acrylate, ethyl acrylate, methyl methacrylate, acrylic acid, methacrylic acid, itaconic acid, acrylamide derivatives, hydroxy-ethyl acrylate, and glycidyl acrylate.

Examples of the vinyl type resin include polyvinyl acetate, an ethylene-vinylacetate copolymer, an acrylic vinyl acetate copolymer, polyvinyl acetal, polyvinyl butyral, a phenol vinylbutyral copolymer, polyvinyl pyrrolidone, and polyvinyl chloride.

Examples of the urethane type resin include polyurethane prepolymers obtained by reaction between polyol and polyisocyanate, wherein examples of the polyol include 1,2-polybutadiene polyol, 1,4-polybutadiene polyol, poly(pentadiene butadiene) polyol, poly(styrene-butadiene rubber) polyol, and poly(butadiene acrylonitrile) polyol, and examples of polyisocyanate include diphenylmethane diisocyanate, tolylene diisocyanate, naphthalene diisocyanate, polymethylene polyphenyl isocyanate, xylylene diisocyanate, lysine diisocyanate, hexamethylene diisocyanate, isophorone diisocyanate, methylenebis(cyclohexylisocyanate).

Further, examples of the water soluble polymer include naturally-occurring polymer polysaccharides, such as xanthan gum, carrageenan, pullulan, furcelleran, curdlan, gelatin and collagen; naturally-occurring low molecular polysaccharides, such as sodium alginate and calcium alginate; polyacrylic acid; sodium polyacrylate; and polyvinyl alcohol.

Examples of the water soluble polymer include methyl alcohol, ethyl alcohol, ethylene glycol, propylene glycol, polyethylene glycol, and glycerol.

The thickness of the toner holding material layer 15 is determined in relationship to the thickness of a toner image T to be held, and for example, is set to 1 to 500 μm.

### [Image Supporting Substrate]

As an image supporting substrate 11 which constitutes an image printed matter P of the present invention, employed are appropriate materials which satisfy a relationship relating to a contact angle with a liquid dispersion medium of a specific gel which constituting a toner holding material layer 15. Examples of the materials include a regular paper from a thin paper to a thick paper; a high quality paper; a coated print sheet, such as an art paper and a coated paper; a Japanese paper and a post card paper which are available in the market; a polypropylene synthetic paper, a polyethylene terephthalate (PET) film, a polyethylene naphthalate (PEN) film, a polyimide film, cloth, and the like. Among them, specifically preferable are materials which have such high strength that their performance is not spoiled even if they are subjected to reuse via a separation treatment mentioned later repeatedly many times, for example, 10 times or more. Examples of image supporting substrates which can be subjected to such reuse repeatedly many times include a stiff or tough regular paper (cardboard), an art paper, a coated paper, a polyethylene terephthalate (PET) film, a polyethylene naphthalate (PEN) film, a polyimide film, and the like.

Such an image supporting substrate 11 may be applied with well-known various kinds of hydrophilization treatment or hydrophobing treatment such that a contact angle of a liquid dispersion medium of a specific gel to the image supporting substrate 11 becomes within the above range.

### [Toner Particles]

The toner particles which form a toner image T relating to the image printed matter P of the present invention contain, for example, at least resin, and further may be made to contain a colorant, a charge controlling agent, a magnetic powder, a release agent and the like in accordance with a request. In the following description, the aggregate of such toner particles is expressed as toner. Hereafter, unused toner particles will be explained.

### [Production Method of Toner Particles]

Examples of the production method of toner particles include, without being limited specifically thereto, a pulverization method, an emulsification dispersion method, a suspension polymerization method, a dispersion polymerization method, an emulsion polymerization method, an emulsion polymerization agglutination method, and other well-known methods.

### [Toner Resin]

In the case where toner particles are produced by the pulverization method, the emulsification dispersion method, or the like, examples of the toner resin include well-known various kinds of resins such as vinyl resins, i.e. styrene resin, (meth)acrylic resin, styrene (meth) acrylic copolymer resin, and olefin resin; polyester resin, polyamide resin, polycarbonate resin, polyether, polyvinyl acetate resin, polysulfone, epoxy resin, polyurethane resin, urea resin, and the like. These may be used solely or in combination of two kinds or more.

On the other hand, in the case where toner particles are produced by a suspension polymerization method, a dispersion polymerization method, an emulsion polymerization method, an emulsion polymerization agglutination method, and the like, examples of polymerlizable monomers to obtain toner particles include vinyl monomers: i.e., styrene or styrene derivatives, such as styrene, o-methylstyrene, m-methylstyrene, p-methylstyrene, α-methylstyrene, p-chloro styrene, 3,4-dichlorostyrene, p-phenylstyrene, p-ethylstyrene, 2,4-dimethylstyrene, p-tert-butyl styrene, p-n-hexylstyrene, p-n-octylstyrene, p-n-nonylstyrene, p-n-decylstyrene, and p-n-dodecylstyrene; methacrylate ester derivatives, such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, and dimethylaminoethyl methacrylate; acrylate ester derivatives, such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, and phenyl acrylate; olefins, such as ethylene, propylene, and isobutylene; vinylic halides, such as vinyl chloride, vinylidene chloride, vinyl bromide, vinyl fluoride, and vinylidene fluoride; vinyl esters, such as vinyl propionate, vinyl acetate, and vinyl benzoate; vinyl ethers, such as vinylmethyl ether and vinylethyl ether, vinyl ketones, such as vinyl methyl ketone, vinyl ethyl ketone, and vinyl hexyl ketone; N-vinyl compounds, such as N-vinylcarbazole, N-vinylindole, and N-vinyl pyrrolidone; Vinyl compounds, such as vinylnaphthalene and vinylpyridine; acrylic acid derivatives or methacrylic acid derivatives, such as acrylonitrile, methacrylonitrile, and acrylamide. These vinyl monomers may be used solely or in combination of two kinds or more.

Further, it is desirable to use a polymerizable monomer having an ionic dissociable group as the polymerizable monomer. The polymerizable monomer having an ionic dissociable group includes, for example, a substituent, such as a carboxyl group, a sulfonic acid group, and a phosphoric acid group, as a structure group. Specific examples of the polymerizable monomer having an ionic dissociable group includes acrylic acid, methacrylic acid, maleic acid, itaconic acid, cinnamic acid, fumaric acid, monoalkyl maleate ester, monoalkyl itaconate ester, styrene sulfonate, allyl sulfosuccinate, 2-acrylamide 2-methylpropane sulfonate, acid phosphooxyethyl methacrylate, and 3-chloro-2-acid phosphooxypropyl methacrylate.

Furthermore, a resin having a cross-linkage structure may be obtained by the use of polyfunctional vinyls, such as divinylbenzene, ethylene glycol dimethacrylate, ethylene glycol diacrylate, diethylene glycol dimethacrylate, diethylene glycol diacrylate, triethylene glycol dimethacrylate, triethylene glycol diacrylate, neopentylglycol dimethacrylate, and neopentylglycol diacrylate.

Elastic toner particles can be obtained by the use of materials exhibiting at least elasticity and/or a shape memory property as a toner resin.

As a toner resin exhibiting a shape memory property, polymer materials, such as elastomer which has a shape memory property, may be employed.

Examples of the elastomer having a shape memory property, include a cross linkage type shape memory elastomer which is made to cross link chemically or physically and a network type shape memory elastomer in which a network polymer and a phase transfer polymer are mixed.

Specific examples of the elastomer having a shape memory property include cross linkage type shape memory polymers, such as polymers in which monomers such as norbornen, styrene, butadiene, isoprene, methyl methacrylate, butyl acrylate, ethylene, propylene, acrylic acid, isofluorone diisocyanate, and oxypropylene glycol, were polymerized with a cross linking agent or chain extending agent, such as benzoyl peroxide, 1,4-butanediol, and ethylene glycol, and polynorbornen, polyurethane, polyisoprene, polyethylene, and a styrene butadiene copolymer in which the above polymers are post cross linked or chain extended after the polymerization; and network type shape memory polymers in which a network polymer, such as an epoxy resin, a phenol resin, an acrylic resin, polyester, and a melanin resin; and a phase transfer polymer, such as polycaprolactone, polyvinyl chloride, polystyrene, polybutylene succinate, polyethylene terephthalate, polybutylene terephthalate, and a polyphenylene sulfide are mixed.

Moreover, as a toner resin which exhibits elasticity, for example, materials which exhibit elasticity, such as elastomer having rubber elasticity may be employed.

Examples of the elastomers which have rubber elasticity, include rubbers such as natural rubber and synthetic rubber, and thermoplastic elastomers which have an alloy structure of rubber and resin providing the rubber with a reinforcing effect, are allowed to flow at high temperature, and are prevented from conducting plastic deformation at ordinary temperature.

Specific examples of the elastomers which have rubber elasticity, include natural rubbers including cis-polyisoprene as major components; natural gutta perchas including trance-polyisoprene as major components; acrylic rubbers made by addition polymerization, or copolymerization of monomers such acrylic acid, butyl acrylate, 1,3-butadiene, 2-chloro-1,3-butadiene, acrylonitrile, isoprene, chloroprene, styrene, α-methylstyrene, p-chloro styrene, isobutylene, hexamethyl siloxane, tetrafluoroethylene, isocyanate, an oxypropylene glycol, epichlorohydrin, ethylene, and propylene; synthetic rubbers, such as acrylonitrile butadiene rubber, isoprene rubber, urethane rubber, ethylene propylene rubber, epichlorohydrin rubber, chloroprene rubber, silicone rubber, styrene butadiene rubber, butadiene rubber, fluororubber and polyisobutylene rubber; a methacrylic acid butadiene copolymer, an acrylic acid butadiene copolymer, a methylmethacrylic acid butadiene copolymer, a styrene butadiene copolymer, a styrene isoprene copolymer, a styrene ethylene butylene copolymer, a styrene ethylene propylene copolymer, a styrene isobutylene copolymer, a methylvinylketone butadiene copolymer, olefin type thermoplastic elastomer (TPO, TPV), vinyl chloride type thermoplastic elastomer (TPVC), amide type thermoplastic elastomer, ester type thermoplastic elastomer, urethane type thermoplastic elastomer, and the like.

### [Colorant]

In the case where toner particles are constituted to include colorant, as the colorant, various kinds and various colors of organic or inorganic pigments which are exemplified below, may be employed.

That is, examples of black pigments include carbon black, copper oxide, manganese dioxide, aniline black, activated carbon, nonmagnetic ferrite, magnetic ferrite, and magnetite.

Examples of yellow pigments include chrome yellow, zinc yellow, cadmium yellow, ferrite oxide yellow, mineral fast yellow, nickel titan yellow, navel orange yellow, naphthol yellow S, hansa yellow G, hansa yellow 10G, benzidine yellow G, benzidine yellow GR, quinoline yellow lake, permanent yellow NCG, and tartrazine lake.

Examples of orange pigments include red chrome yellow, molybdenum orange, permanent orange G TR, pyrazolone orange, Balkan orange, indusren brilliant orange RK, benzidine orange G, and indusren brilliant orange GK.

Examples of red pigments include quinacridone, colcothar, cadmium red, red lead, mercury sulfide, cadmium, permanent red 4R, lithol red, pyrazolone red, watchung red, calcium salt, lake red C, lake red D, brilliant carmine 6B, eosine lake, rhodamine lake B, alizarin lake, and brilliant carmine 3B.

Examples of purple pigments include manganese purple, fast violet B, and methyl violet lake.

Examples of blue pigments include berlin blue, cobalt blue, alkali blue lake, victoria blue lake, metal phthalocyanine blue, non-metal phthalocyanine blue, phthalocyanine blue partial chlorination product, fast sky blue, and indusren blue BC.

Examples of green pigments include chrome green, chrome oxide, pigment green B, mica light green lake, and final yellow green G.

Examples of white pigments include zinc white, titanium oxide, antimony white, and zinc sulfide.

Moreover, examples of extender pigments include baryta powder, barium carbonate, clay, silica, white carbon, talc, and alumina white.

These pigments may be used solely or in combination of two or more kinds.

The additive amount of the colorant is preferably 0.5 to 20 parts by weight to 100 parts by weight of a toner resin, and more preferably 2 to 10 parts by weight.

### [Magnetic Powder]

In the case where toner particles are constituted to include magnetic powder, as the magnetic powder, for example, magnetite, γ-hematite, and various ferrites may be employed. The additive amount of the magnetic powder is preferably 10 to 500 parts by weight to 100 parts by weight of a toner resin, and more preferably 20 to 200 parts by weight.

### [Charge Controlling Agent]

In the case where toner particles are constituted to include a charge controlling agent, as the charge controlling agent, if substances can provide positive or negative charge by frictional electrification, the substances may be employed without being limited to. Specifically, well-known various positive charge controlling agents and negative charge controlling agents may be employed. Specific examples of the positive charge controlling agents include Nigrosine series dye compounds, such as “Nigrosine Base EX” (manufactured by Orient Chemical Industries Co., Ltd.); quarternary ammonium salts, such as “Quarternary ammonium salt P-51” (manufactured by Orient Chemical Industries Co., Ltd.) and “Copy charge PX VP435” (manufactured by Hoechst Japan Limited); and imidazole compounds, such as alkoxy-modified amine, alkyl amide, molybdic acid chelate pigments, and “PLZ1001” (manufactured by Shikoku Chemicals Corporation). Specific examples of the negative charge controlling agents include metal complexes, such as “BONTRON S-22” (manufactured by Orient Chemical Industries Co., Ltd.), “BONTRON S-34” (manufactured by Orient Chemical Industries Co., Ltd.), “BONTRON E-81” (manufactured by Orient Chemical Industries Co., Ltd.), “BONTRON E-84” (manufactured by Orient Chemical Industries Co., Ltd.), and “Spiron black TRH” (manufactured by Hodogaya Chemical Co., Ltd.); quarternary ammonium salts, such as thioindigo system pigments and “Copy charge NX VP434” (manufactured by Hoechst Japan); carixarene compounds, such as “BONTRON E-89” (manufactured by Orient Chemical Industries Co., Ltd.); boron compounds, such as “LR147” (manufactured by Japan Carlit Co., Ltd.); and fluorine compounds, such as magnesium fluoride, carbon fluoride, and the like. Examples of metal complexes employed as the negative charge controlling agents include, in addition to the above compounds, compounds having various structures, such as an oxycarboxylic acid metal complex, a dicarboxylic acid metal complex, an amino acid metal complex, a diketone metal complex, an diamine metal complex, an azo-containing benzene-benzene derivative skeleton metal body, an azo-containing benzene-naphthalene derivative skeleton metal complex, and the like. With the constitution that toner particles contain a charge controlling agent, the charging ability of toner can be enhanced.

The additive amount of the charge controlling agent is preferably 0.01 to 30 parts by weight to 100 parts by weight of a toner resin, and more preferably 0.1 to 10 parts by weight

### [Release Agent]

In the case where toner particles are constituted to include a release agent, as the release agent, well-known various kinds of wax may be employed. As the wax, it is preferable to employ polyolefin type waxes, such as low molecular weight polypropylene and polyethylene or oxidation type polypropylene and polyethylene.

The additive amount of the release agent is preferably 0.1 to 30 parts by weight to 100 parts by weight of a toner resin, and more preferably 1 to 10 parts by weight.

### [Particle Size of Toner Particles]

The particle size of toner particles is preferably 3 to 8 μm in volume-based median size. When the volume-based median size is 3 to 8 μm, the reproducing of fine lines and the realization of high quality of photographic image can be attained, and the consumption of toner can be reduced as compared with the case where large particle size toner is used.

The volume-based median size of toner particles is measured and calculated by the use of a measurement apparatus in which a computer system (manufactured by Beckman Coulter) mounting a data processing soft “Software V3.51” is connected to “COULTER Multisizer 3” (manufactured by Beckman Coulter Inc.). Concretely, 0.02 g of toner particles are added into 20 mL of a surfactant solution (for the purpose of dispersing toner particles, for example, a surfactant solution in which a neutral detergent containing surfactant components is diluted by ten times with purified water) and is made to become familiar with the solution, and thereafter the resultant solution is subjected to an ultrasonic dispersion treatment for one minute so as to prepare a dispersion liquid of toner particles. Then, this dispersion liquid of toner particles is put by a pipette into a beaker containing “ISOONII” (manufactured by Beckman Coulter Inc.) placed in a sample stand until a displayed concentration on the measurement device becomes 8%. Here, this concentration range makes it possible to obtain reproducible measurement values. In this measurement device, the count number of measured particles is set to 25,000 pieces, an aperture size is set to 50 μm, and a measurement range of 1 to 30 μm is divided into 256 divisions. In the measurement, a frequency value is calculated for each division, and then, a 50% particle size from the large side of a volume cumulative fraction is made as a volume-based median

### [Average Degree of Circularity of Toner Particles]

The average degree of circularity of toner particles represented by the following formula (S) is preferably 0.700 to 1.000, and more preferably 0.850 to 1.000.

Average degree of circularity=(a peripheral length of a circle obtained from a circle-corresponding diameter)/(a peripheral length of particle-projected image) Formula (S)

### [External Additive Agent]

The abovementioned toner particles may constitute toner as it is. However, in order to improve flowability, electrostatic property, cleaning property, and the like, external additive agents, such as a fluidizer and a cleaning auxiliary agent that are post processing agents, may be added into the toner particles.

Examples of the post processing agents include inorganic fine particles, such as inorganic oxide fine particles, such as, silica fine particles, alumina fine particle, and titanium oxide fine particles; inorganic stearic acid compound fine particles, such as aluminum stearate fine particles and zinc stearate fine particles; and inorganic titanic acid compound fine particles, such as such as strontium titanate, zinc titanate, and the like. These may used solely or in combination of two or more kinds. From a viewpoint of a heat-resistant storage stability and environmental stability, it is desirable that above inorganic fine particles are subjected to a surface treatment with a silane coupling agent, a titanium coupling agent, a higher fatty acid, silicone oil, and the like. The sum of the additive amounts of these various external additive agents is made to 0.05 to 5 parts by weight to 100 parts by weight of toner particles, and preferably 0.1 to 3 parts by weight. Further, the external additive agents may be used in combination of various kinds of them.

### [Developer]

The abovementioned toner may be used as a magnetic or nonmagnetic one component developer, and also may be used as a two component developer by being mixed with carrier. In the case where such toner is used as a one component developer for image formation, the one component developer may be a nonmagnetic one component developer or a magnetic one component developer in which toner includes magnetic fine particles with a size of about 0.1 to 0.5 μm, and either of them can be used. Further, in the case where such toner is used as a two component developer, examples of carrier include magnetic particles composed of conventionally well-known materials, such as metals, i.e., iron, ferrite, and magnetite; and alloys of those metals and aluminium or lead, and specifically, ferrite particles are preferable. Further, examples of such carrier include a coated carrier in which the surfaces of magnetic particles are covered with covering material, such as resin, and a resin dispersion type carrier in which magnetic substance fine powders are dispersed in a binder resin.

### [Surface Protection Layer]

From a viewpoint of for example, provision of storage ability and pencil writable property, the surface protection layer 13 is provided if needed, and it is made to have translucency. Examples of materials constituting the surface protection layer 13 include film materials composed of polyethylene terephthalate (PET), polyethylene naphthalate (PEN), polypropylene (PP), or polystyrene (PS); organic solvent soluble resins, such as a polystyrene resin, an acrylic resin, and a polyester resin, and hardened products of surface protection layer forming solutions such as light hardening agents, heat hardening agents, and moisture hardening agents. Furthermore, as the surface protection layer forming solutions, materials having the same composition as that of materials used to form the toner holding material layer 15 may be employed.

The thickness of the surface protection layer 13 is preferably 10 to 200 μm, and more preferably 25 to 100 μm.

According to the above image printed matter P, since the toner image T is held in the toner holding material layer 15, its surface is made to a state with high uniformity so as to make no level difference between an image-formed portion Q and a non-image-formed portion and to provide high image quality. Furthermore, since a material composed of a gel formed by a liquid dispersion medium having a contact angle within a specific range to the image supporting substrate 11 is used as the toner holding material layer 15, a sufficient close contact can be obtained between the image supporting substrate 11 and the toner holding material layer 15 so as to provide a high image strength without causing image collapse due to peel-off between the image supporting substrate 11 and the toner holding material layer 15 by a small external force. Moreover, the liquid dispersion medium is prevented from transferring to the image supporting substrate 11, whereby a change of an image over time is not caused and an image printed matter with excellent image stability can be obtained.

### [Reuse of Toner Particles]

It is desirable that toner particles are separated from an image printed matter P obtained by the image forming method of the present invention via a separation treatment, and toner (hereafter, also referred to as “toner for reuse” or “reuse toner”) containing these separated toner particles can be reused as an image formation material so as to obtain an another image printed matter. Although specific types of the image forming method are not limited, the abovementioned specific image forming method may be preferably employed. When the abovementioned specific image forming method and the separation treatment of toner particles are alternately repeated, a reuse system (recycling system) capable of achieving energy saving can be established.

In this reuse system, when the degree of particle shape of toner particles used to form a toner image constituting an image printed matter P is made A and the degree of particle shape of separated toner particles from this image printed matter P is made C, it is preferable to satisfy the following relational expression (II).

1.0≧C/A≧0.9 Relational expression (II)

The value of (C/A) represents a magnitude of change of a degree of particle shape of toner particle between before being used for forming a toner image and after having been subjected to the separation treatment, and when the value of (C/A) is within the range of the above-mentioned relational expression (II), since toner particles constituting the toner for reuse exhibit the same behavior as that of the initial toner particles, the toner particles can be used again for the abovementioned specific image forming method. On the other hand, when the value of (C/A) representing the magnitude of change of a degree of particle shape is less than 0.9, since there is fear that toner particles constituting the toner for reuse exhibit behavior different from that of the initial toner particles, it becomes difficult to use the toner particles again for the abovementioned specific image forming method.

The degree of particle shape C of toner particles constituting toner for reuse is concretely obtained as fallows. Toner particles are subjected to an appropriate separation treatment so as to be separated from an image printed matter. The separated toner particles are observed by a scanning electron microscope (SEM) “JSM-7401F” (manufactured by JEOL Co., Ltd.) so as to take an image with a magnification of 2,000 times into “a LUZEX image analyze” (manufactured by Nireco Corp.). Then, a maximum diameter and minimum diameter of a projection image of a particle are measured for each toner particle, and a degree of particle shape is obtained by the calculation of (minimum diameter/maximum diameter). Subsequently, the degree of particle shape C of toner particles is obtained by the calculation of an average value of the respective degrees of particle shape of 100 toner particles.

The degree of particle shape C of toner particles constituting toner for reuse is preferably 0.40 to 1.00 in concrete terms, and more preferably 0.60 to 1.00.

Toner particles for reuse can be obtained in such a way that a toner holding material layer 15 holding a toner image is immersed in a separation treatment liquid which can dissolve or swell a gel material forming the toner holding material layer and does not make the toner particles dissolve. An object made immersed in the separation treatment liquid is an image printed matter P or a toner holding material layer 15 which is peeled off from an image supporting substrate 11 and holds a toner image T. Also, such toner particles for reuse can be obtained in another way that a toner holding material layer 15 is peeled off from an image supporting layer 11 and is subjected to a wipe treatment to scrub with a cloth the surface of the toner holding material layer 15 on which a toner image is held is. Further, in the case where toner particles used for a toner image have magnetism, toner particles for reuse can be obtained by the following ways. In the first way, in an image printed matter P, a magnetic force is applied on a surface of an image supporting substrate 11 which is the opposite surface (the lower surface in FIG. 1c) to the surface of the image supporting substrate 11 which comes in contact with a toner holding material layer 15. On the condition that a toner image is held on the image supporting substrate 11 by the magnetic force, the toner holding material layer is peeled oft Subsequently, the application of the magnetic force is released, and then toner particles are separated from the image supporting substrate 11. In the second way, a toner holding material layer 15 is peeled off from an image printed matter P while holding a toner image T, and then toner particles are separated from the toner holding material layer 15 by the action of a magnetic force.

### [Separation Treatment Liquid]

In the case where the specific gel is organogels, such as a silicone gel, examples of the separation treatment liquid which can dissolve or swell a gel material and does not make toner particles dissolve, include dimethyl silicone oil, methyl-phenyl silicone oil, methyl hydrogen silicone oil, amino modified silicone oil, epoxy modified silicone oil, polyether modified silicone oil, carboxyl modified silicone oil, aminopolyether modified silicone oil, and the like. In the case where the specific gel is hydrogels, such as an acrylic gel, a urethane gel, and a silicone gel, examples of the separation treatment liquid include water, methyl alcohol, ethyl alcohol, ethylene glycol, polyethylene glycol, glycerol, a mixture of them. In order to improve the compatibility of the separation treatment liquid with toner particles, a gel material forming a toner holding material layer 15, and an image supporting substrate 11, a surface active agent may be added into the separation treatment liquid.

When a separation treatment liquid solution of toner particles and a gel material separated by being immersed in a separation treatment liquid is subjected to a separation process, for example, by a centrifugal separator, the toner particles and the gel material can be collected respectively.

In the case where separated toner particles are toner particles to which external additives were added before separation, toner for reuse may be obtained by being added with a shortage amount of the external additives to a required amount. Further, for example, in the case where toner particles are manufactured by the use of a material having shape memory properties as a toner resin and their shapes deform, toner particles which are collected on the deforming condition are subjected a separation treatment to apply an appropriate restoration treatment to restore the deformed shape, and thereafter, the toner particles are added with a shortage amount of the external additives to a required amount, whereby toner for reuse can be obtained.

An external additive adhering on separated toner particles can be quantified, for example, by an X-ray fluorescence spectrometer. Concretely, it can be measures by an X-ray fluorescence spectrometer “XRF-1700” (manufactured by Shimadzu Corp.).

A difference between energy necessary for forming an image printed matter P(N) obtained by the use of toner particles granulated from raw materials and energy necessary for forming an image printed matter P(R) obtained by the use of reuse toner containing the abovementioned separated toner particles substantially corresponds to the magnitude obtained by subtracting energy relating to a separation treatment or the subtotal (hereafter, referred to as “treatment energy relating to reuse”) of energy relating to a separation treatment and energy relating to addition of a shortage amount of external additives from initial granulation energy necessary for granulating toner particles from raw materials. Since the treatment energy relating to reuse is smaller than the initial granulation energy, large energy saving can be attained.

### [Reuse of a Toner Holding Material Layer]

In a reuse system, it is desirable that a toner holding material layer 15 is separated from an image printed matter P via a separation treatment and this separated toner holding material layer (hereafter, also referred to as “toner holding material layer for reuse” or “reuse toner holding material layer”) can be reused as an image formation material so as to be used for the abovementioned specific image forming method. When the abovementioned specific image forming method and the separation treatment of the toner holding material layer are alternately repeated, a reuse system (recycling system) capable of achieving energy saving can be established.

A reuse toner holding material layer can be obtained in such a way that a toner holding material layer 15 holding a toner image is peeled off from an image supporting substrate 11 and subjected to a wipe treatment to scrub with a cloth the surface of the toner holding material layer 15 on which a toner image is held is. Further, for example, it can be also obtained in an anther way that a toner holding material layer 15 holding a toner image is peeled off from an image supporting substrate 11, toner particles are removed by the action of a magnetic force from the toner holding material layer 15, and the solid state toner holding material layer 15 from which the toner particles have been removed is made to still standing. The peel-off of a toner holding material layer 15 from an image supporting substrate 11 can be achieved by pulling the toner holding material layer 15 into a peel-off direction by a proper force such as a man power. Further, a toner holding material layer 15 can be peeled off by being immersed in a solvent whose contact angle to an image supporting substrate 11 is smaller than that of a liquid dispersion medium of a specific gel constituting the toner holding material layer 15.

### [Reuse of an Image Supporting Substrate]

Furthermore, in a reuse system, it is desirable that an image supporting substrate is separated from an image printed matter P via a separation treatment and this separated image supporting substrate (hereafter, also referred to as “image supporting substrate for reuse” or “reuse image supporting substrate”) can be reused as an image formation material so as to obtain an another image printed matter. Especially, it is desirable that it is used for the abovementioned specific image forming method. In this reuse system, it is desirable from a viewpoint of energy saving that the image supporting substrate is reused by 10 times or more. When the abovementioned specific image forming method and the separation treatment of the toner holding material layer are alternately repeated, a reuse system (recycling system) capable of achieving energy saving can be established.

The reuse image supporting substrate can be obtained by peeling directly the toner holding material layer 15 holding a toner image T. Further, it can be obtained such a way that an image printed matter is immersed in a separation treatment liquid which can dissolve or swell a gel material and does not make the image supporting substrate dissolve.

A difference between energy necessary for forming an image printed matter P(N) obtained by the use of an initial image supporting substrate produced from raw materials and energy necessary for forming an image printed matter P(R) obtained by the use of a reuse image supporting substrate collected in the above way substantially corresponds to the magnitude obtained by subtracting energy relating to a separation treatment from initial production energy necessary for producing an initial image supporting substrate from raw materials. Since the energy relating to the separation treatment is extremely small as compared with the initial production energy, large energy saving can be attained.

As mentioned above, according to the method which employs separated toner particles, and/or a toner holding material layer, and/or an image supporting substrate which were separated from an obtained image printed matter, large energy saving can be attained as a whole. Further, in this method, for a toner holding material layer 15 of an image printed matter P, employed is a specific gel composed of a liquid dispersion medium having a contact angle within a specific range to an image supporting substrate 11. Therefore, the peel-off of the toner holding material layer 15 from the image supporting substrate 11 can be conducted quickly and surely, whereby the toner holding material layer 15 and the image supporting substrate 11 can be reused in a simple way.

### Second Embodiment

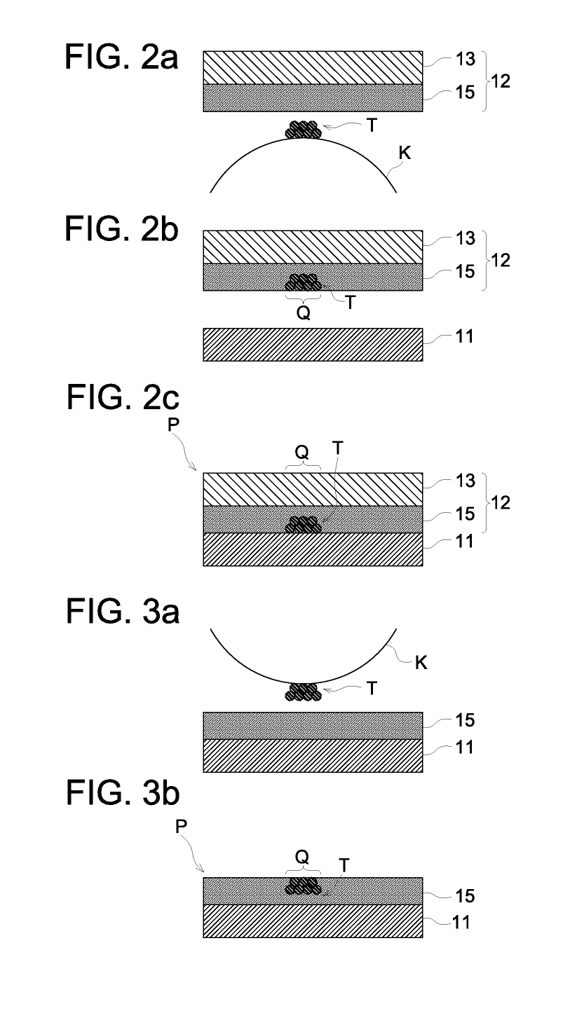

The image forming method relating to the second embodiment of the present invention has the same requirements as the first embodiment except that as shown in FIGS. 2a to 2c, by the use of an image fixing sheet 12 in which a toner holding material layer 15 is formed on a surface protective layer 13, a toner image is embedded in the toner holding material layer 15 of the image fixing sheet 12 by an external force, and then the image fixing sheet 12 in which the toner holding material layer 15 holds the toner image T is superimposed on the image supporting substrate 11 such that the toner holding material layer 15 comes in contact with the image supporting substrate 11, whereby the toner image T is fixed on the image supporting substrate 11. According to this image forming method, it becomes possible to obtain the same effect as that in the first embodiment.

In the image forming method relating to the second embodiment, by the use of an image fixing sheet in which an intermediate transfer member is employed in place of the surface protective layer 13 and a toner holding layer 15 is formed on the intermediate transfer member, the image fixing sheet 12 in which the toner holding layer 15 holds the toner image T is superimposed on the image supporting substrate 11, and then the intermediate transfer member is peeled off, whereby the toner image T may be fixed on the image supporting substrate 11.

### Third Embodiment

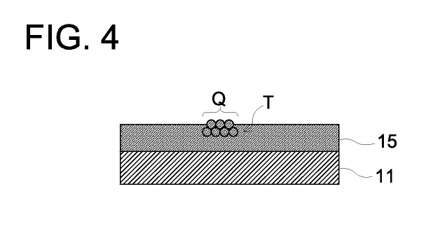

The image forming method relating to the third embodiment of the present invention has the same requirements as the first embodiment except that as shown in FIGS. 3a and 3b, a toner image is embedded in a toner holding material layer 15 laminated on an image supporting substrate 11, whereby the toner image T is fixed on the image supporting substrate 11. With regard to the toner image T fixed in the toner holding material layer 15, it is desirable that as shown in FIG. 4, 50 volume percent or more of each toner particle of all toner particles constituting the toner image T is embedded, and especially, as shown in FIG. 3b, 100 volume percent of each toner of all toner particles is embedded. According to this image forming method, it becomes possible to obtain the same effect as that in the first embodiment.

As mentioned above, the embodiments of the present invention have been explained concretely. However, the embodiment of the present invention is not limited to the above embodiments, and various modifications may be applied.

### Example

Hereafter, although the concrete examples of the present invention will be described, the present invention should not be limited to these examples.

### [Synthesis Example 1 of Toner Particles]

Into a polymer bottle, 10.0 parts by weight of copper phthalocyanine pigment, 90.0 parts by weight of styrene, 10.0 parts by weight of methyl methacrylate, and 260 parts by weight of 1 mm diameter glass beads were put, dispersed for 4 hours by a paint shaker and subjected to a separation treatment with a mesh so as to separate the glass beads, whereby a color material dispersion liquid [1] was prepared.

Further, into 66.0 parts by weight of the color material dispersion liquid [1], 40.0 parts by weight of divinylbenzene, and 1.6 pares by weight of azobisisobutyronitrile were added, and stirred by a Three-one motor at a stirring rate of 200 rpm for 15 minutes, whereby a color material dispersion liquid [2] was prepared.

Further, 2.5 pats by weight of sodium dodecyl sulfonate and 100.0 pats by weight of polyvinyl alcohol were dissolved in 500.0 by weight of ion exchange water, whereby a water-based dispersion liquid [3] was prepared.

Then, into a container with a large bottom, the color material dispersion liquid [2] and the water-based dispersion liquid [3] were fed, and stirred by a TK homo-mixer at a stirring rate of 6000 rpm for 20 minutes, whereby an O/W emulsion [4] was prepared.

Successively, into a reaction container equipped with a stirring device, a heating and cooling device, a nitrogen introducing device, and a raw material and auxiliary agent feeding device, the O/W emulsion [4] was supplied, the internal temperature was raised to 70° C. while being stirred at a stirring rate of 200 rpm under nitrogen stream, and polymerization was conducted for 4 hours, whereby a fine particle dispersion liquid was obtained. This fine particle dispersion liquid was subjected repeatedly to filtration and water washing, whereby a dispersion liquid of toner particles [1] with a volume average particle size of 6.2 μm and an average degree of circularity being 0.99 were obtained.

This dispersion liquid of toner particles [1] was adjusted with ion exchange water such that the solid content of the dispersion liquid became 20 weight percent To 100 parts by weight of these toner particles [1], 1.0 weight percent of PTFE fine particles “TF5032F” (manufactured by Sumitomo 3M Limited) was added, processed by a TK homo-mixer, then dried, and further, 0.5 weight percent of silica fine particles “H-2000” (manufactured by Hoechst Japan Limited) were added to 100 parts by weight of these toner particles [1], and processed by a Henschel mixer, whereby toner [1] was obtained. The shape and particle size of toner particles [1] were not changed by the addition of the P E fine particles and the silica fine particles.

### [Preparation Example 1 of Developer]

Developer [1] being a two component developer was prepared by mixing toner [1] with silicon acrylic-coated carrier such that a weight ratio became 6:94.

### Example 1

### (1) Production of an Initial Image Printed Matter

On a transparent PET sheet [A] with a thickness of 30 μm (surface protective layer), a silicone gel “SE1891H” (manufactured by Dow Corning Toray Co., Ltd.) (a specific gel) was coated by a bar coater and hardened, whereby an image fixing sheet [1] having a flexible toner holding material layer with a thickness of 30 μm and a penetration of 45 was produced. On an ink jet paper sheet “DH1” (manufactured by Konica Minolta Corporation) [B] (image supporting substrate) which had a contact angle of 70 degrees for oil and a contact angle of 9 degrees for water, a toner image formed by the developer [1] was transferred by “bizhub C 253” (manufactured by Konica Minolta Business Technologies Inc.) in which a fixing device was dismounted. Subsequently, on the ink jet paper sheet [B], the above image fixing sheet [1] was superimposed such that the toner holding material layer come in contact with the toner image, and the resultant product was made to pass through the dismounted fixing device without heating so as to be applied with pressure, whereby an initial image printed matter [1] in which the image fixing sheet [1] holding the toner image was laminated on the ink jet paper sheet [B] was obtained.

### (2) Separation Treatment

### Evaluation of Peel-Off Performance

For the initial image printed matter [1], the image fixing sheet [1] holding the toner image was pulled in the peel-off direction by a man power, the image fixing sheet [1] could be peeled off from the ink jet paper sheet [B].

The peeled surface of the peeled image fixing sheet [1] which had been in contact with the ink jet paper sheet [B] was wiped with a cloth into which dimethyl silicone oil “SH200 (100CS)” (manufactured by Dow Corning Toray Co., Ltd.) was infiltrated, so as to collect toner, then the cloth was immersed in a 0.01 wt % SDS aqueous solution and applied with an ultrasonic wave so as to disperse toner particles, and the toner particles were subjected repeatedly to filtration and water washing and were dried, whereby the toner particles were recovered. The recovery ratio of toner particles from the initial image printed matter [1] was 99% by weight conversion.

These recovered separated toner particles were mixed as reuse toner particles [1-2] with carrier, whereby reuse developer [1-2] was obtained. On the other hand, the image fixing sheet [1] which has been wiped with the cloth was made as a reuse image fixing sheet [1-2] as it was. Further, the ink jet paper sheet [B] was made as a reuse ink jet paper sheet [B-2] as it was.

### (3) Production of a Recycled Image Printed Matter

A recycled image printed matter [1-2] was obtained by the use of the reuse developer [1-2], the reuse ink jet paper sheet [B-2], and the reuse image fixing sheet [1-2] in the same way as the initial image printed matter [1] relating to Example 1. In the visual observation, this recycled image printed matter [1-2] did not have any difference in image quality as compared with the initial printed matter [1].

### Example 2

### (1) Production of an Initial Image Printed Matter

On a transparent PET sheet [A] with a thickness of 30 μm (surface protective layer), a hydrogel “Technogel AG” (manufactured by Sekisui Plastics Co., Ltd.) (specific gel) with a thickness of 100 μm was superimposed, whereby an image fixing sheet [2] having a flexible toner holding material layer was produced.

An initial image printed matter [2] was obtained in the same way as that in Example 1 except that at (1) production process of an initial image printed matter, a YUPO (registered trademark) “FGS” (manufactured by YUPO Corporation) [C] which had a contact angle of 10 degrees for oil and a contact angle of 80 degrees for water was used as an image supporting substrate in place of the ink jet paper sheet [B].

### (2) Separation Treatment

### Evaluation of Peel-Off Performance

For the initial image printed matter [2], the image fixing sheet [2] holding the toner image was pulled in the peel-off direction by a man power, the image fixing sheet [2] could be peeled off from the YUPO (registered trademark) [C].

The peeled surface of the peeled image fixing sheet [2] which had been in contact with the YUPO (registered trademark) [C] was wiped with a cloth into which water was infiltrated, so as to collect toner particles. The recovery ratio of toner particles from the initial image printed matter [2] was 99% by weight conversion.

These recovered separated toner particles were mixed as reuse toner particles [1-3] with carrier, whereby reuse developer [1-3] was obtained. On the other hand, the image fixing sheet [2] which has been wiped with the cloth was made as a reuse image fixing sheet [2-2] as it was. Further, the YUPO (registered trademark) [C] separated by peeling was made as a reuse YUPO (registered trademark) [C-2] as it was.

### (3) Production of a Recycled Image Printed Matter

A recycled image printed matter [2-2] was obtained by the use of the reuse developer [1-3], the reuse YUPO (registered trademark) [C-2], and the reuse image fixing sheet [2-2] in the same way as the initial image printed matter [2] relating to Example 2. In the visual observation, this recycled image printed matter [2-2] did not have any difference in image quality as compared with the initial printed matter [2].

### Comparative Example 1

### (1) Production of an Initial Image Printed Matter

A comparative initial image printed matter [3] was obtained in the same way as that in Example 1 except that at the production process of the initial image printed matter, a YUPO (registered trademark) [C] was used in place of the ink jet paper sheet [B].

### (2) Separation Treatment

### Evaluation of Peel-Off Performance

For the initial image printed matter [3], the image fixing sheet [1] holding the toner image was pilled in the peel-off direction by a man power, the toner holding material layer composed of silicone gel in the image fixing sheet [1] could not be peeled off from the YUPO (registered trademark) [C].

### Comparative Example 2

### (1) Production of an Initial Image Printed Matter

A comparative initial image printed matter [4] was obtained in the same way as that in Example 2 except that at the production process of the initial image printed matter, an ink jet paper sheet [B] was used in place of the YUPO (registered trademark) [C].

### (2) Separation Treatment

### Evaluation of Peel-Off Performance

For the initial image printed matter [4], the image fixing sheet [2] holding the toner image was pulled in the peel-off direction by a man power, the toner holding material layer composed of hydro gel in the image fixing sheet [2] could not be peeled off from the ink jet paper sheet [B].

### Comparative Example 3

### (1) Production of an Initial Image Printed Matter

A comparative initial image printed matter [5] was obtained in the same way as that in Example 2 except that at the production process of the initial image printed matter, a glass plate [D] which was treated with “HIREC450” (manufactured by NIT Advanced Technology Corp.) was used in place of the YUPO (registered trademark) [C].

### (2) Separation Treatment

### Evaluation of Peel-Off Performance

For the initial image printed matter [5], the image fixing sheet [2] holding the toner image was pulled in the peel-off direction by a man power, the toner holding material layer could not be peeled off from the glass plate [D].

### [Evaluation for Image Stability]

The above initial image printed matters [1] to [5] were left uncontrolled under the environment of normal temperature and normal humidity for one week respectively, and the respective images before and after the operation were visually observed. As a result, in the initial image printed matters [1], [2], and [5] relating to Example 1, Example 2, and Comparative example 3, no image change over time was observed. On the other hand, in the initial image printed matters [3] and [4], image disturbance occurred after one week. The image disturbance was estimated due to the shift of the liquid dispersion medium in the gel to the image supporting substrate and the shrinkage of the gel accompanying the shift.

### [Evaluation of Image Intensity]

For each of the obtained initial image printed matters [1] to [5], a flannel cloth was pushed on the image portion with a pressure of 1 kPa, moved back and forth by three and half times so as to rub the image portion, and then separated from the image portion. Thereafter, 20 monitor persons visually checked the resultant condition in comparison with the initial condition and evaluated based on the following criterions.

Not accept: Image collapse due to peel-off between the image supporting substrate and the toner holding material layer occurred even if only slightly.

Accept: Other than the above, namely, image collapse due to peel-off between the image supporting substrate and the toner holding material layer did not occurred at all.

The evaluation results were judged based on the following criterions.

Good: 18 or more monitor persons judged “Accept”.

Bad: other than the above.

The results are shown in Table 1.

TABLE 1

| | Image | Image supporting substrate | | | Kind of | | | |
|---|---|---|---|---|---|---|---|---|
| | printed | | Contact angle | | liquid | Evaluation result | | |
| | matter | | Oil | Water | dispersion | Image | Image | Peel |
| | No. | Kind | (Degree) | (Degree) | medium | intensity | stability | property |
| Example 1 | 1 | Ink jet | 70 | 9 | Oil | Good | Good | Good |
| | | paper [B] | | | | | | |
| Example 2 | 2 | YUPO ™ | 10 | 80 | Water | Good | Good | Good |
| | | [C] | | | | | | |
| Comparative | 3 | YUPO ™ | 10 | 80 | Oil | Good | Deformed | Bad |
| example 1 | | [C] | | | | | | |
| Comparative | 4 | Ink jet | 70 | 9 | Water | Good | Deformed | Bad |
| example 2 | | paper [B] | | | | | | |
| Comparative | 5 | Glass plate | 140 | 150 | Water | Bad | Good | Good |
| example 3 | | [D] | | | | | | |

The above-mentioned preferable embodiments of the present invention may be summarized as follows.

The image printed matter of the present invention is an image printed matter in which a toner holding material layer is laminated on an image supporting substrate and a toner image composed of toner particles is held by the toner holding material layer, and the image printed matter is characterized in that the toner holding material layer is composed of a gel formed by a liquid dispersion medium having a contact angle of 20 to 110 degrees to the image supporting substrate.

The image forming method of the present invention is an image forming method which makes an image supporting substrate to support a toner image formed by toner particles thereon, and then laminates a toner holding material layer so as to make the toner holding layer hold the toner image so that an image printed matter is formed, and the image forming method is characterized in that the toner holding material layer is composed of a gel formed by a liquid dispersion medium having a contact angle of 20 to 110 degrees to the image supporting substrate.

The image forming method of the present invention is an image forming method which makes a toner holding layer hold a toner image formed by toner particles and laminates the toner holding material layer on an image supporting substrate so that an image printed matter is formed, and the image forming method is characterized in that the toner holding material layer is composed of a gel formed by a liquid dispersion medium having a contact angle of 20 to 110 degrees to the image supporting substrate.

The image forming method of the present invention is an image forming method which makes a toner holding layer, which is laminated on an image supporting substrate, to hold a toner image formed by toner particles so that an image printed matter is formed, and the image forming method is characterized in that the toner holding material layer is composed of a gel formed by a liquid dispersion medium having a contact angle of 20 to 110 degrees to the image supporting substrate.

The image forming method of the present invention is characterized by obtaining an image printed matter by use of toner particles separated from an image printed matter obtained by the abovementioned image forming method.

The image forming method of the present invention is characterized by obtaining an image printed matter by use of an image supporting substrate separated from an image printed matter obtained by the abovementioned image forming method.

The image forming method of the present invention is an image forming method which makes an image supporting substrate to support a toner image formed by toner particles thereon, and then laminates a toner holding material layer, which is composed of a gel formed by a liquid dispersion medium having a contact angle of 20 to 110 degrees to the image supporting substrate, so as to make the toner holding layer hold the toner image so that an image printed matter is formed, and the image forming method is characterized in that at least any one of toner particles constituting the toner image, the toner holding material layer, and the image supporting substrate is separated from an image printed matter obtained by the above image forming methods.

The image forming method of the present invention is an image forming method which makes a toner holding layer, which is composed of a gel formed by a liquid dispersion medium having a contact angle of 20 to 110 degrees to the image supporting substrate, to hold a toner image formed by toner particles and laminates the toner holding material layer on an image supporting substrate so that an image printed matter is formed, and the image forming method is characterized in that at least any one of toner particles constituting the toner image, the toner holding material layer, and the image supporting substrate is separated from an image printed matter obtained by the above image forming methods.

The image forming method of the present invention is an image forming method which makes a toner holding layer, which is laminated on an image supporting substrate and is composed of a gel formed by a liquid dispersion medium having a contact angle of 20 to 110 degrees to the image supporting substrate, to hold a toner image formed by toner particles so that an image printed matter is formed, and the image forming method is characterized in that at least any one of toner particles constituting the toner image, the toner holding material layer, and the image supporting substrate is separated from an image printed matter obtained by the above image forming methods.

According to the above image printed matter, since the toner image is held in the toner holding material layer, its surface is made to a state with high uniformity so as to make no level difference between image-formed portions and non-image-formed portions and to provide high image quality. Furthermore, since a material composed of a gel formed by a liquid dispersion medium having a contact angle within a specific range to the image supporting substrate is used as the toner holding material layer, a sufficient close contact can be obtained between the image supporting substrate and the toner holding material layer so as to provide a high image strength without causing image collapse due to peel-off between the image supporting substrate and the toner holding material layer by a small external force. Moreover, the liquid dispersion medium is prevented from transferring to the image supporting substrate, whereby a change of an image over time is not caused and an image printed matter with excellent image stability can be obtained.

According to the above image forming methods, since a toner image can be fixed onto an image supporting substrate basically without providing heat, energy saving can be attained. Further, since the toner image is held in the toner holding material layer, its surface is made to a state with high uniformity so as to make no level difference between image-formed portions and non-image-formed portions and to provide high image quality. Furthermore, since a material composed of a gel formed by a liquid dispersion medium having a contact angle within a specific range to the image supporting substrate is used as the toner holding material layer, a sufficient close contact can be obtained between the image supporting substrate and the toner holding material layer so as to provide a high image strength without causing image collapse due to peel-off between the image supporting substrate and the toner holding material layer by a small external force. Moreover, the liquid dispersion medium is prevented from transferring to the image supporting substrate, whereby a change of an image over time is not caused and an image printed matter with excellent image stability can be obtained.

According to the method which employs separated toner particles, and/or a toner holding material layer, and/or an image supporting substrate which were separated from an obtained image printed matter, large energy saving can be attained as a whole. Further, in this method, for a toner holding material layer of an image printed matter, employed is a specific gel composed of a liquid dispersion medium having a contact angle within a specific range to an image supporting substrate. Therefore, the peel-off of the toner holding material layer from the image supporting substrate can be conducted quickly and surely, whereby the toner holding material layer and the image supporting substrate can be reused in a simple way.

What is claimed is:

1. An image forming method for forming an image printed matter, comprising the steps of:
forming a toner image with toner particles on a photoreceptor,
transferring the toner image from the photoreceptor onto a substrate;
laminating an toner holding material layer on the substrate so as to embed the toner image in the toner holding material layer so that the toner holding material layer holds the toner image therein and the image printed matter is formed,
wherein the toner holding material layer is composed of a gel including a liquid dispersion medium having a contact angle of 20 to 110 degrees to the image supporting substrate.

2. The image forming method described in claim 1, wherein the gel is an organogel composed of a dispersed material such as resin, elastomer, and rubber, and an organic solvent or oil.

3. The image forming method described in claim 1, wherein the gel is a hydrogel composed of a dispersed material such as resin, elastomer, rubber, and a water soluble polymer, and a water-based solvent.

4. The image forming method described in claim 1, wherein the substrate is subjected to hydrophilization treatment or hydrophobing treatment such that the contact angle of the liquid dispersion medium becomes 20 to 110 degrees to the substrate.

5. The image forming method described in claim 1, wherein a pressing force of 1.00×10³ to 1.00×10⁸ Pa is applied onto the toner holding material layer so as to embed the toner image in the toner holding material layer.

6. The image forming method described in claim 1, wherein when a degree of particle shape of toner particles used to form the toner image is A and a degree of particle shape of toner particles constituting the toner image held by the toner holding material layer is B, the following expression (I) is satisfied,
1.0≧B/A≧0.9 Expression (I)
where the degree of particle shape of toner particles is represented by (minimum diameter of a projection image of a toner particle/maximum diameter of the projection image).

7. The image forming method described in claim 1, wherein the degree of particle shape A is 0.40 to 1.00.

8. The image forming method described in claim 1, wherein the degree ofparticle shape B is 0.40 to 1.00.

9. The image forming method described in claim 1, wherein the toner particles have a 10% deformation intensity of 1 to 100 MPa.

10. The image forming method described in claim 1, wherein the toner particles have a recovery ratio of 70% or more.

11. An image forming method for forming an image printed matter, comprising the steps of
forming a toner image with toner particles on a photoreceptor,
transferring the toner image from the photoreceptor onto an toner holding material layer so as to make the toner holding material layer hold the toner image therein;
laminating the toner holding material layer on a substrate so that the image printed matter is formed,
wherein the toner holding material layer is composed of a gel including a liquid dispersion medium having a contact angle of 20 to 110 degrees to the image supporting substrate.

12. An image forming method for forming an image printed matter, comprising the steps of
forming a toner image with toner particles on a photoreceptor,
transferring the toner image from the photoreceptor onto a toner holding material layer laminated on a substrate so that the toner holding material layer holds the toner image therein and the image printed matter is formed,
wherein the toner holding material layer is composed of a gel including a liquid dispersion medium having a contact angle of 20 to 110 degrees to the image supporting substrate.

13. An image printed matter, comprising:
a substrate;
a toner holding material layer laminated on the substrate; and
a toner image held between the substrate and the toner holding material layer in such a way that the toner image is embedded in the toner holding material layer,
wherein the toner holding material layer is composed of a gel including a liquid dispersion medium having a contact angle of 20 to 110 degrees to the image supporting substrate.

14. An image forming method for forming an image printed matter, comprising the steps of
separating toner particles, the substrate, and the toner holding material layer from the image printed matter described in claim 13; and
forming an image printed matter by reusing at least one of the separated toner particles, substrate, and toner holding material layer.
